(19) United States
(12) Patent Application Publication
(10) Pub. No.: US 2007/0002853 A1
(43) Pub. Date: Jan. 4, 2007

(54) Snoop bandwidth reduction

(76) Inventors: Anil Vasudevan, Portland, OR (US); D. Michael Bell, Beaverton, OR (US); Sujoy Sen, Portland, OR (US); Parthasarathy Sarangam, Portland, OR (US)

Correspondence Address: CAVEN & AGHEVLI;c/o PORTFOLIOIP, P.O. BOX 52050, MINNEAPOLIS, MN, 55402, US

(21) Appl. No.: 11/171,597

(22) Filed: Jun. 30, 2005

(51) Int. Cl. H04L 12/56

(52) U.S. Cl. 370/389; 370/413

(57) ABSTRACT

In one embodiment, it may be determined whether a processor is going to access a packet payload that is stored in a source buffer. If the processor is not going to access the packet payload, a data movement module (DMM) may move the packet payload from the source buffer to a destination buffer.

### BACKGROUND

Networking has become an integral part of computer systems. Advances in network bandwidths, however, have not been fully utilized due to overhead that may be associated with processing protocol stacks. A protocol stack generally refers to a set of procedures or programs that may be executed to handle packets sent over a network, where the packets may conform to a specified protocol. For example, TCP/IP (Transport Control Protocol/Internet Protocol) packets may be processed using a TCP/IP stack.

Overhead associated with processing protocol stacks may result from bottlenecks in a computer system from using a central processing unit (CPU) to perform slow memory access functions such as data movement. Such overhead may be reduced by partitioning protocol stack processing. For example, TCP/IP stack processing may be offloaded to a TCP/IP offload engine (TOE). Also, the entire TCP/IP stack may be offloaded to a networking component, such as a MAC (media access control) component, of an I/O subsystem, such as a NIC (network interface card). However, valuable CPU cycles may still be spent on monitoring or snooping memory transactions communicated via a bus that is connected to the CPU.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates various components of an embodiment of a networking environment, which may be utilized to implement various embodiments discussed herein.

FIGS. 2 and 5 illustrate block diagrams of embodiments of computing systems, which may be utilized to implement various embodiments discussed herein.

FIG. 3 illustrates a block diagram of an embodiment of a method to process a packet.

FIG. 4 illustrates a block diagram of an embodiment of a method to reduce snoop bandwidth.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

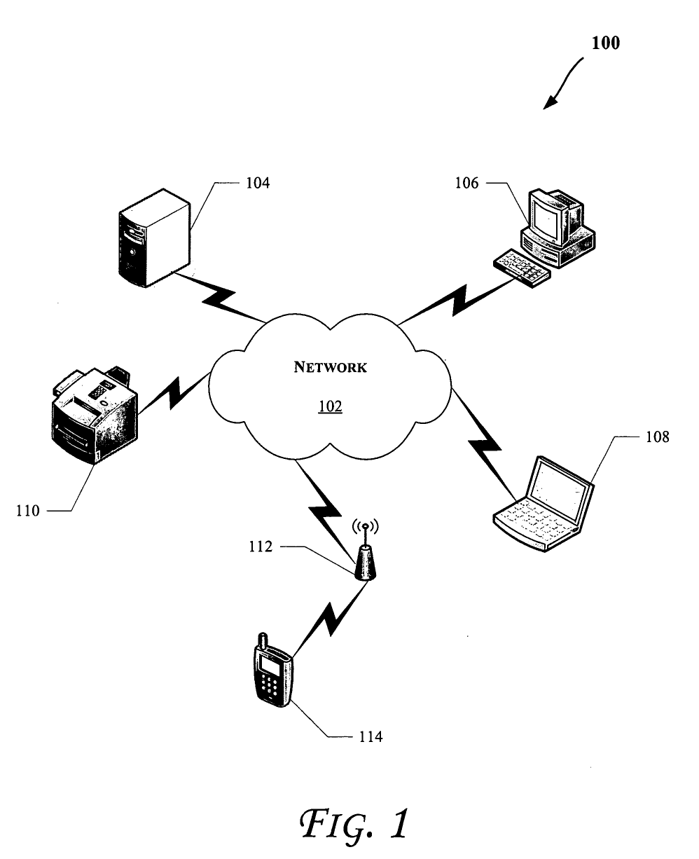

FIG. 1 illustrates various components of an embodiment of a networking environment 100, which may be utilized to implement various embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, or the like), a wireless access point 112, a personal digital assistant or smart phone 114, a rack-mounted computing system (not shown), or the like. The network 102 may be any suitable type of a computer network including an intranet, the Internet, and/or combinations thereof.

The devices 104-114 may be coupled to the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any suitable communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), or the like), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), or the like. Moreover, network communication may be established by internal network interface devices (e.g., present within the same physical enclosure as a computing system) or external network interface devices (e.g., having a separate physical enclosure and/or power supply than the computing system to which it is coupled) such as a network interface card (NIC).

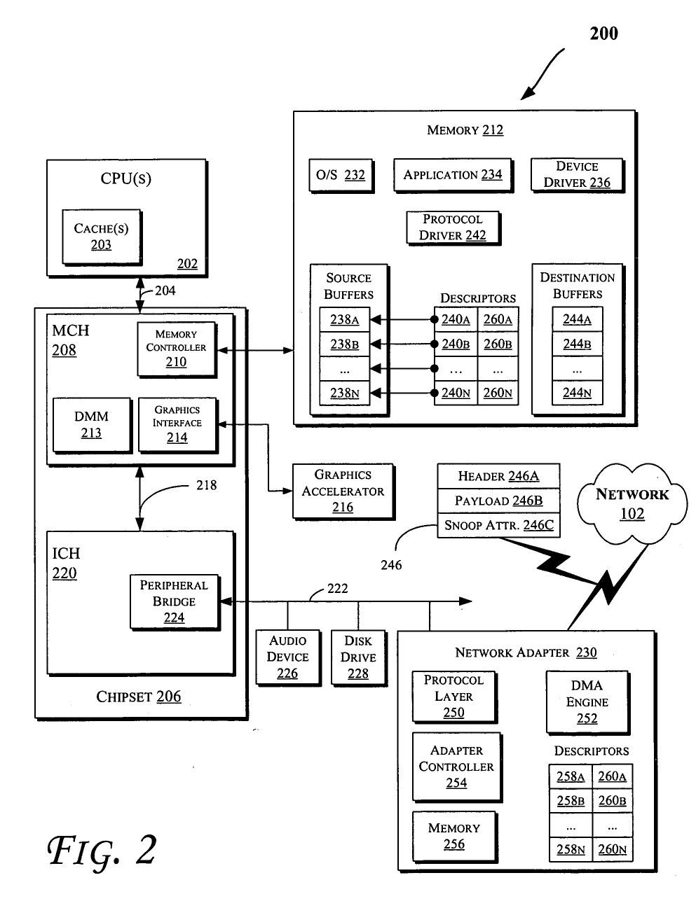

FIG. 2 illustrates a block diagram of an embodiment of a computing system 200. One or more of the devices 104-114 discussed with reference to FIG. 1 may comprise the computing system 200. The computing system 200 may include one or more central processing unit(s) (CPUs) 202 or processors coupled to an interconnection network (or bus) 204. The processors (202) may be any suitable processor such as a general purpose processor, a network processor, or the like (including a reduced instruction set computer (RISC) processor or a complex instruction set computer (CISC)). Moreover, the processors (202) may have a single or multiple core design. The processors (202) with a multiple core design may integrate different types of processor cores on the same integrated circuit (IC) die. Also, the processors (202) with a multiple core design may be implemented as symmetrical or asymmetrical multiprocessors.

The processor 202 may include one or more caches (203), which may be shared in one embodiment of the invention. Generally, a cache stores data corresponding to original data stored elsewhere or computed earlier. To reduce memory access latency, once data is stored in a cache, future use may be made by accessing a cached copy rather than refetching or recomputing the original data. The cache 203 may be any suitable cache, such a level 1 (L1) cache, a level 2 (L2) cache, a level 3 (L-3), or the like to store instructions and/or data that are utilized by one or more components of the system 200.

A chipset 206 may additionally be coupled to the interconnection network 204. The chipset 206 may include a memory control hub (MCH) 208. The MCH 208 may include a memory controller 210 that is coupled to a memory 212. The memory 212 may store data and sequences of instructions that are executed by the processor 202, or any other device included in the computing system 200. In one embodiment of the invention, the memory 212 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 204, such as multiple processors and/or multiple system memories.

The MCH 208 may additionally include a graphics interface 214 coupled to a graphics accelerator 216. In one embodiment, the graphics interface 214 may be coupled to the graphics accelerator 216 via an accelerated graphics port (AGP). In an embodiment of the invention, a display (such as a flat panel display) may be coupled to the graphics interface 214 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

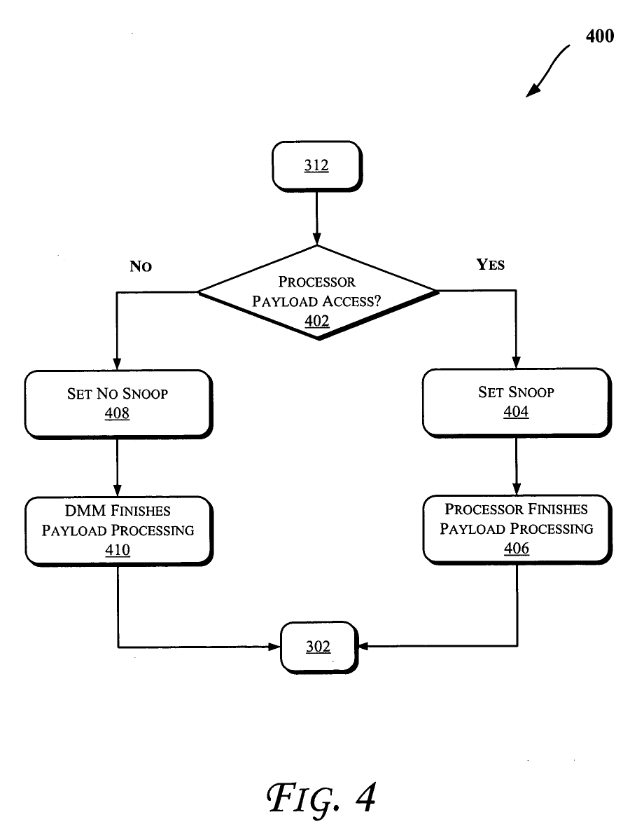

The MCH 208 may further include a data movement module (DMM) 213, such as a DMA (direct memory access) engine. As will be further discussed herein, e.g., with reference to FIG. 4, the DMM 213 may provide data movement (e.g., data copying) support to improve the performance of a computing system (200). For example, in some instances, there may be a significant time gap between when data is copied from a source to a destination versus when the data is accessed by an application. Hence, the DMM 213 may perform one or more data copying tasks instead of involving the processors 202. Furthermore, since the memory 212 may store the data being copied by the DMM 213, the DMM 213 may be located in a location near the memory 212, for example, within the MCH 208, the memory controller 210, the chipset 206, or the like. However, the DMM 213 may be located elsewhere in the system 200 such as within the processor(s) 202.

Referring to FIG. 2, a hub interface 218 may couple the MCH 208 to an input/output control hub (ICH) 220. The ICH 220 may provide an interface to input/output (I/O) devices coupled to the computing system 200. The ICH 220 may be coupled to a bus 222 through a peripheral bridge (or controller) 224, such as a peripheral component interconnect (PCI) bridge, a universal serial bus (USB) controller, or the like. The bridge 224 may provide a data path between the processor 202 and peripheral devices. Other types of topologies may be utilized. Also, multiple buses may be coupled to the ICH 220, e.g., through multiple bridges or controllers. For example, the bus 222 may comply with the PCI Local Bus Specification, Revision 3.0, Mar. 9, 2004, available from the PCI Special Interest Group, Portland, Oreg., U.S.A. (hereinafter referred to as a “PCI bus”). Alternatively, the bus 222 may comprise a bus that complies with the PCI-X Specification Rev. 2.0a, Apr. 23, 2003, (hereinafter referred to as a “PCI-X bus”), available from the aforesaid PCI Special Interest Group, Portland, Oreg., U.S.A. Alternatively, the bus 222 may comprise other types and configurations of bus systems. Moreover, other peripherals coupled to the ICH 220 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 222 may be coupled to an audio device 226, one or more disk drive(s) 228, and a network adapter 230. Other devices may be coupled to the bus 222. Also, various components (such as the network adapter 230) may be coupled to the MCH 208 in some embodiments of the invention. In addition, the processor 202 and the MCH 208 may be combined to form a single chip. Furthermore, the graphics accelerator 216 may be included within the MCH 208 in other embodiments of the invention.

Additionally, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media suitable for storing electronic instructions and/or data.

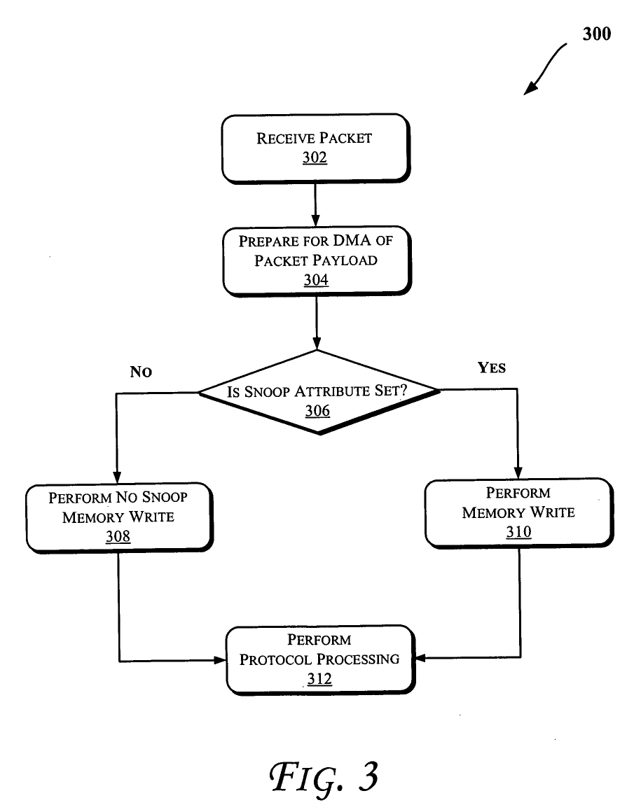

The memory 212 may include one or more of the following in an embodiment: an operating system (O/S) 232, application 234, device driver 236, buffers 238, descriptors 240, protocol driver 242, and destination buffers 244. Programs and/or data in the memory 212 may be swapped into the disk drive 228 as part of memory management operations. The application(s) 234 may execute (on the processor(s) 202) to communicate one or more packets 246 with one or more computing devices coupled to the network 102 (such as the devices 104-114 of FIG. 1). In an embodiment, a packet may be a sequence of one or more symbols and/or values that may be encoded by one or more electrical signals transmitted from at least one sender to at least on receiver (e.g., over a network such as the network 102). For example, each packet 246 may have a header 246A that includes various information that may be utilized in routing and/or processing the packet 246, such as a source address, a destination address, packet type, etc. Each packet may also have a payload 246B that includes the raw data (or content) the packet is transferring between various computing devices (e.g., the devices 104-114 of FIG. 1) over a computer network (such as the network 102). As will be further discussed with reference to FIG. 3, the packet 246 may also include a snoop attribute 246C in an embodiment.

In an embodiment, the application 234 may utilize the O/S 232 to communicate with various components of the system 200, e.g., through the device driver 236. Hence, the device driver 236 may include network adapter (230) specific commands to provide a communication interface between the O/S 232 and the network adapter 230. For example, the device driver 236 may allocate one or more source buffers (238A through 238N) to store packet data, such as the packet payload 246B. One or more descriptors (240A through 240N) may respectively point to the source buffers 238. A protocol driver 242 may implement a protocol driver to process packets sent over the network 102, according to one or more protocols.

In an embodiment, the O/S 232 may include a protocol stack that provides the protocol driver 242. A protocol stack generally refers to a set of procedures or programs that may be executed to process packets sent over a network (102), where the packets may conform to a specified protocol. For example, TCP/IP (Transport Control Protocol/Internet Protocol) packets may be processed using a TCP/IP stack. The device driver 236 may indicate the source buffers 238 to the protocol driver 242 for processing, e.g., via the protocol stack. The protocol driver 242 may either copy the buffer content (238) to its own protocol buffer (not shown) or use the original buffer(s) (238) indicated by the device driver 236.

In one embodiment, the data stored in the buffers 238 may be copied to the destination buffers 244 as will be further discussed with reference to FIG. 4. For example, depending on whether a snoop (or “no snoop”) status bit of a received packet is set, the processor(s) 202 (or the DMM 213) may invoke snoop access to be handled by the processor(s) 202.

As illustrated in FIG. 2, the network adapter 230 may include a (network) protocol layer 250 for implementing the physical communication layer to send and receive network packets to and from remote devices over the network 102. The network 102 may include any suitable computer network such as those discussed with reference to FIG. 1. The network adapter 230 may further include a DMA engine 252, which writes packets to buffers (238) assigned to available descriptors (240). Additionally, the network adapter 230 may include a network adapter controller 254, which includes hardware (e.g., logic circuitry) and/or a programmable processor to perform adapter related operations. In an embodiment, the adapter controller 254 may be a MAC (media access control) component. The network adapter 230 may further include a memory 256, such as any suitable volatile/nonvolatile memory, and may include one or more cache(s).

In one embodiment, network adapter 230 may maintain descriptors 258A through 258N, each corresponding to one of the descriptors 240A through 240N. The descriptors 258 may be implemented in hardware registers and/or implemented as software descriptors, e.g., in the memory 254. In certain embodiments, the descriptors 258 may be stored in the memory 212, and the network adapter 230 may load the descriptors 258 into hardware registers of the network adaptor 230. Hence, descriptors may be represented in both the network adapter 230 (e.g., as hardware registers) and the memory 212 (e.g., as software elements accessible by the drivers 236 and 242).

Further, the descriptors 240 and/or 258 may be shared between the drivers (236 and/or 242) and components of the network adapter 230. For example, a descriptor (240) may be stored in memory 212 and the device driver 236 may write a buffer address (e.g., the address of one of the source buffers 238) in the descriptor (240) and submit the descriptor (240) to the network adapter 230. The adapter 230 may then load a corresponding local descriptor (258) with the buffer address stored in the corresponding descriptor (240) and use the buffer address to direct memory access (DMA) packet data into the network adapter 230 hardware to process (e.g., through the DMA engine 252). When the DMA operations are complete, the hardware may “write back” the descriptor (258) to the corresponding descriptor (240) and/or buffer (238) in the memory 212 (e.g., with a “Descriptor Done” bit, and other possible status bits). The device driver 236 may then take the descriptor (240) which is “done” and indicate the corresponding buffer to the protocol driver 242, e.g., for protocol processing.

FIG. 3 illustrates a block diagram of an embodiment of a method 300 to process a packet. In an embodiment, various components of the system 200 of FIG. 2 may be utilized to perform one or more of the operations discussed with reference to FIG. 3. For example, the network adapter 230 may perform the stages 302-310 and the driver(s) 236 and/or 242 may perform the stage 312.

Referring to FIGS. 2 and 3, the computing system 200 may receive a packet (302) from a computer network. For example, the network adapter 230 may utilize the protocol layer 250 to receive the packet 246 from the network 102. The packet may be prepared for DMA of packet payload (304), such as discussed with reference to the DMA engine 252. For example, the network adapter 230 may utilize the adapter controller 254 to parse the packet 246, e.g., by splitting the packet header 246A and payload 246B. Also, at the stage 304, the DMA engine 252 may determine which descriptor (258 and/or 240) is available.

At a stage 306, the network adapter 230 (e.g., the adapter controller 254) may determine if a snoop attribute (246C) of the received packet is set. In an embodiment, a status bit (246C) may indicate (e.g., by a 0 or 1) whether that packet has its snoop attribute set (or “no snoop” attribute set). Snooping may generally refer to monitoring memory transactions communicated via a shared bus, interface, or interconnection network. For example, the processor(s) (202) may snoop the memory transactions communicated via the interconnection network 204, hub interface 218, and/or bus 222. However, each time a processor (202) snoops, valuable cycles may be spent on monitoring transactions, resulting in system performance hits. Hence, if the “no snoop” attribute is set (306), a no snoop memory write transaction may be performed (308) by other components of the system 200 without involving any transactions on the interconnection network 204. For example, the DMA engine 252 may write the packet payload (246C) to an available source buffer (238), e.g., as indicated by a corresponding descriptor (258 and/or 240) that was determined to be available at the stage 304.

Alternatively, if the stage 306 determines that the snoop attribute is set (or the no snoop attribute is clear), a memory write may be performed (310) that involves a snoop access by the processor(s) 202. After the stages 308 and 310, the method 300 continues with a stage 312, which performs protocol processing such as discussed with reference to the drivers (236 and/or 242) of FIG. 2. For example, the device driver 236 may indicate the source buffer (238) that includes the written packet payload (308, 310) to the protocol driver 242 for protocol processing after writing the corresponding buffer (238). The protocol driver 242 may either copy the buffer content (238) to its own protocol buffer (not shown) or use the original buffer(s) (238) indicated by the device driver 236 when performing the stage 312.

FIG. 4 illustrates a block diagram of an embodiment of a method 400 to reduce snoop bandwidth. In an embodiment, various components of the system 200 of FIG. 2 may be utilized to perform one or more of the operations discussed with reference to FIG. 4. For example, the device driver (236) of FIG. 2 may perform the stages 402-404 and 408. Also, the processor(s) 202 may perform the stage 406 and the DMM 213 may perform the stage 410.

Referring to FIGS. 2 and 4, after protocol processing (e.g., such as discussed with reference to the stage 312 of FIG. 3), the device driver (236) may determine whether one or more of the processors 202 are going to access the packet payload (246C) of a packet (246), e.g., the packet received at the stage 302 of FIG. 3. For example, if the DMM 213 is present in the system, the processors 202 may not access the packet payload (246C), e.g., to move or copy the payload (246C) from a source buffer (238) to a destination buffer (244). Additionally, the processor(s) 202 may peak into the payload (246C) for other reasons, such as preexisting demands by one or more applications (234) to access the packet payload (246C). If the stage 402 determines that one or more of the processors 202 are going to access the packet payload, the device driver 236 may set a snoop attribute (260) corresponding to the packet payload (404), e.g., by setting or clearing a status bit (260) of a corresponding descriptor (258 and/or 240). The processor(s) 202 may finish processing of the payload (406), e.g., by copying the payload (246C) from a source buffer (238) to a destination buffer (244).

Alternatively, if the stage 402 determines that one or more of the processors 202 are not going to access the packet payload, the device driver 236 may set a no snoop attribute (260) corresponding to the packet payload (408), e.g., by setting or clearing a status bit (260) of a corresponding descriptor (258 and/or 240). The DMM 213 may finish processing of the payload (410), e.g., by copying the payload from a source buffer (238) to a destination buffer (244), without invoking a snoop access to be handled by the processor(s) 202. The method 400 may continue with the stage 302 of FIG. 3, e.g., to receive other packets from the network 102.

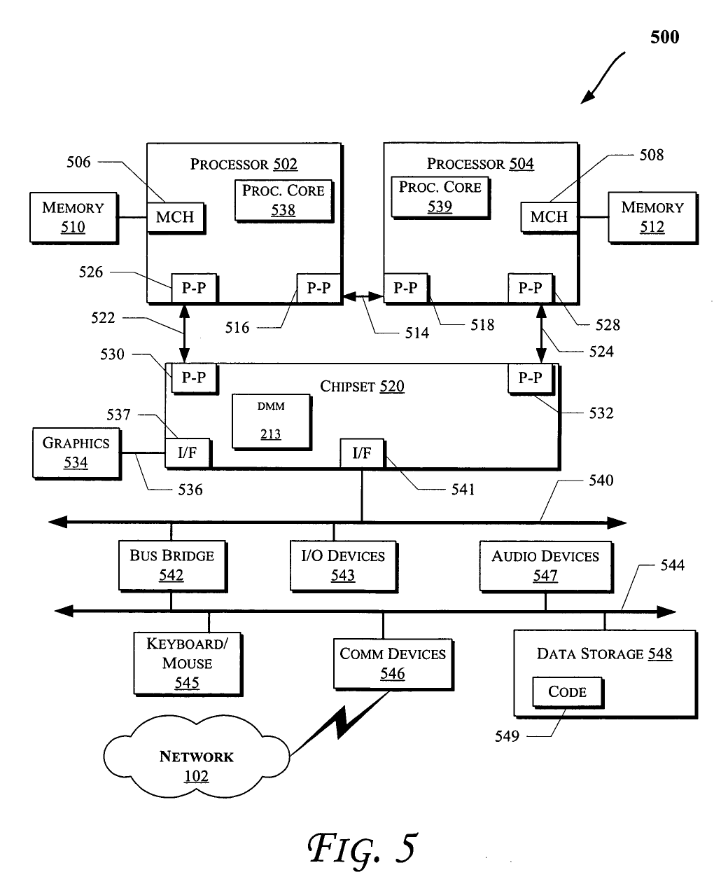

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. One or more of the devices 104-114 discussed with reference to FIG. 1 may include the system 500. Also, the operations discussed with reference to FIGS. 3-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to couple with memories 510 and 512. The memories 510 and/or 512 may store various data such as those discussed with reference to the memory 212 of FIG. 2. For example, each of the memories 510 and/or 512 may include one or more of the O/S 232, application 234, drivers 236 and 242, source buffers 238, descriptors 240 (with attributes 260), and/or destination buffers 244.

The processors 502 and 504 may be any suitable processor such as those discussed with reference to the processors 202 of FIG. 2. The processors 502 and 504 may exchange data via a point-to-point (PtP) interface 514 using PtP interface circuits 516 and 518, respectively. The processors 502 and 504 may each exchange data with a chipset 520 via individual PtP interfaces 522 and 524 using point to point interface circuits 526, 528, 530, and 532. The chipset 520 may also exchange data with a high-performance graphics circuit 534 via a high-performance graphics interface 536, using a PtP interface circuit 537.

At least one embodiment of the invention may be located within the processors 502 and 504. For example, the DMM 213 may be located within the processors 502 and 504. Other embodiments of the invention, however, may exist in other circuits, logic units, or devices within the system 500 of FIG. 5. For example, as illustrated in FIG. 5, the DMM 213 may be located within the chipset 520. Furthermore, other embodiments of the invention may be distributed throughout several circuits, logic units, or devices illustrated in FIG. 5.

The chipset 520 may be coupled to a bus 540 using a PtP interface circuit 541. The bus 540 may have one or more devices coupled to it, such as a bus bridge 542 and I/O devices 543. Via a bus 544, the bus bridge 543 may be coupled to other devices such as a keyboard/mouse 545, communication devices 546 (such as modems, network interface devices, or the like), audio I/O device, and/or a data storage device 548. The data storage device 548 may store code 549 that may be executed by the processors 502 and/or 504. For example, the packet 246 discussed with reference to FIG. 3 may be received from the network 102 by the system 500 through the communication devices 546. The packet 246 may also be received through the I/O devices 543, or other devices coupled to the chipset 520.

In various embodiments, one or more of the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions used to program a computer to perform a process discussed herein. The machine-readable medium may include any suitable storage device such as those discussed with reference to FIGS. 2 and 5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with that embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a network adapter to receive a packet and write a payload of the packet to a source buffer;
a processor to determine whether the processor is going to access the packet payload; and
a data movement module (DMM) to move the packet payload from the source buffer to a destination buffer if the processor is not going to access the packet payload.

2. The apparatus of claim 1, further comprising a memory coupled to the processor and the network adapter to store one or more of the source buffer or the destination buffer.

3. The apparatus of claim 1, wherein the network adapter comprises a direct memory access (DMA) engine to write the packet payload to the source buffer.

4. The apparatus of claim 1, wherein the network adapter comprises one or more descriptors corresponding to one or more source buffers.

5. The apparatus of claim 1, wherein the network adapter determines a status of a snoop attribute of the packet and performs a no snoop memory write transaction to store the packet payload in the source buffer if the snoop attribute of the packet is clear.

6. The apparatus of claim 1, wherein the network adapter is coupled to a computer network to receive the packet.

7. The apparatus of claim 1, further comprising a memory controller that comprises the DMM.

8. A method comprising:
writing a payload of a received packet to a source buffer;
determining whether a processor is going to access the packet payload; and
a data movement module (DMM) moving the packet payload from the source buffer to a destination buffer if the processor is not going to access the packet payload.

9. The method of claim 8, further comprising determining a status of a snoop attribute of the packet.

10. The method of claim 9, wherein the writing of the payload comprises performing a no snoop memory write transaction to store the packet payload in the source buffer if the snoop attribute of the packet is clear.

11. The method of claim 9, wherein the writing of the payload comprises performing a snoop memory write transaction to store the packet payload in the source buffer if the snoop attribute of the packet is set.

12. The method of claim 8, further comprising performing protocol processing on the packet after the packet payload is written to the source buffer.

13. The method of claim 8, further comprising preparing the packet for direct memory access (DMA) of the packet payload.

14. The method of claim 8, further comprising setting a no snoop attribute if the processor is not going to access the packet payload.

15. The method of claim 8, further comprising setting a snoop attribute if the processor is going to access the packet payload.

16. A computer-readable medium comprising:
stored instructions to write a payload of a received packet to a source buffer;
stored instructions to determine whether a processor is going to access the packet payload; and
stored instructions to move the packet payload from the source buffer to a destination buffer by a data movement module (DMM) if the processor is not going to access the packet payload.

17. The computer-readable medium of claim 16, further comprising stored instructions to determine a status of a snoop attribute of the packet.

18. A system comprising:
a volatile memory to store a source buffer and a destination buffer;
a network adapter to receive a packet and write a payload of the packet to the source buffer;
a processor to determine whether the processor is going to access the packet payload; and
a data movement module (DMM) to move the packet payload from the source buffer to a destination buffer if the processor is not going to access the packet payload.

19. The system of claim 18, further comprising a memory controller that comprises the DMM.

20. The system of claim 18, wherein the memory comprises one or more of a RAM, DRAM, SRAM, or SDRAM.
